(19) United States
(12) Patent Application Publication
(10) Pub. No.: US 2011/0182676 A1
(43) Pub. Date: Jul. 28, 2011

(54) TOOL WHICH CAN BE AXIALLY ADJUSTED

(75) Inventors: Peter Frank, Floh-Seligenthal (DE); Jens Querengässer, Floh-Seligenthal (DE)

(73) Assignee: SANDVIK INTELLECTUAL PROPERTY AB, Sandviken (SE)

(21) Appl. No.: 13/054,440

(22) PCT Filed: Jul. 7, 2009
(86) PCT No.: PCT/EP09/58621

§ 371 Date: Apr. 8, 2011

(30) Foreign Application Priority Data
Jul. 18, 2008 (DE) 10 2008 040 562.0

(51) Int. Cl. B23B 29/03; B23C 5/24

(52) U.S. Cl. 407/44

(57) ABSTRACT

The present invention concerns a tool for cutting machining for boring or milling comprising a main tool body rotatable about a tool axis and a holding element which can be fastened to the main tool body and has a cutting insert seat. To provide a tool which is simple and inexpensive to produce and which permits axial adjustment of the cutting insert in relation to the main tool body to a large extent in comparison with the state of the art it is proposed in accordance with the invention that there is provided an adjusting device for axially adjusting the holding element in relation to the main tool body.

The present invention concerns a tool for cutting machining for boring or milling comprising a main tool body rotatable about a tool axis and a holding element which can be fastened to the main tool body and has a cutting insert seat for a cutting insert. Such a tool is known for example from DE 103 15 394 A1. That boring-out tool has a drive shaft and serves for example for enlarging a pre-worked bore.

During the machining operation the tool rotates about a central axis, also referred to as the tool axis or boring axis, which is substantially perpendicularly to the end face of the main tool body. When the tool is inserted into a pre-worked bore the cutting inserts carried on the holding element come into engagement with the internal contour of the bore, enlarge it, and possibly provide for final machining of the internal surfaces.

With some boring tools the boring diameter can be varied by the holding elements being displaceable to a limited extent in the radial direction, that is to say perpendicularly to the tool axis.

There are situations of use, such as for example in step boring, in which multi-step machining operations are involved. For example successively disposed bores of different diameters, frequent bores with countersinks or also combinations of various bores and countersinks may be desired. To minimize the machine time combination tools are then used in which the cutting inserts are set differently both in the radial and also in the axial direction.

With such combination tools the cutting insert seats are admittedly spaced from each other in the axial direction but axial adjustability is however not possible here.

There are already tools in which the cutting inserts can be displaced in the axial direction to a limited extent. For that purpose, inserted between the cutting insert on the one hand and the holding element on the other hand is a wedge for a support disk which provides for axial adjustment of the cutting insert.

That limited axial adjustability however weakens the hold for the cutting insert in the seat, which is designed only for one given position of the cutting insert. In addition reversible cutting inserts are frequently used so that the axial adjustment is no longer correct by virtue of correspondingly worn cutting inserts when the reversible cutting insert is turned.

Therefore the object of the present invention is to provide a tool which is simple and inexpensive to produce and which permits axial adjustment of the cutting insert in relation to the main tool body to a large extent, in comparison with the state of the art.

According to the invention that object is attained in that there is provided an adjusting device for axially adjusting the holding element in relation to the main tool body.

In contrast to the devices in the state of the art it is proposed in accordance with the invention that the holding element together with the cutting insert seat and thus together with the cutting insert is axially adjusted, and not just the cutting insert.

It will be appreciated that there can be provided a slider body which can be fastened to the main tool body and which is reciprocatable in the radial direction relative to the main tool body between two positions, wherein the holding element can be fastened to the slider body. For radial and axial adjustment of the cutting insert in relation to the main tool body therefore firstly the slider body is adjusted in the radial direction relative to the main tool body and then the holding element is adjusted in the axial direction relative to the slider body.

Preferably the adjusting device has an adjusting screw which is arranged in a first threaded bore in the main tool body or in the slider body and which possibly bears by way of a contact portion against a contact surface of the holding element so that upon rotation of the adjusting screw in the threaded bore the holding element is displaced axially with respect to the slider body or the main tool body.

In a preferred embodiment the first threaded bore includes with the tool axis an angle of between 15° and 165°, preferably between 45° and 135°, particularly preferably between 60° and 120° and best at about 90°.

Preferably the contact surface of the holding element or a corresponding abutment surface of the adjusting screw or the contact portion, that comes into engagement with the contact surface of the holding element, includes with the first threaded bore an angle of between 0° and 90°, preferably between 0° and 20° and particularly preferably between 10° and 20°.

In addition in many embodiments there can be provided a spring element which biases the holding element into a given axial position.

In a further preferred embodiment the holding element has a second threaded bore and the slider body or the main tool body has a through bore so that the holding element can be fastened to the slider body or to the main tool body with a fixing screw engaging through the through bore into the second threaded bore.

Advantageously the through bore is in the form of a slot.

In a further preferred embodiment the holding element has a leg-shaped projection and the slider body or the main tool body has a corresponding groove, wherein preferably the second threaded bore is arranged in the leg-shaped projection and the through bore is arranged in the groove.

In addition there can be provided an abutment surface for the fixing screw head on the slider body or the main tool body, wherein the abutment surface includes with the bottom of the groove an angle >0°, preferably between 1° and 20° and particularly preferably between 1° and 10°.

In a preferred embodiment the second threaded bore includes with the radial direction an angle of between 15° and 165°, preferably between 25° and 135° and particularly preferably between 40° and 50°.

In a further particularly preferred embodiment there is provided an extension arm which on the one hand is fastened to the main tool body and which on the other hand carries the cutting insert holder, wherein the cutting insert holder can be fastened to the extension arm at at least two positions spaced from each other in the radial direction.

Further advantages, features and possible uses will be apparent from the description hereinafter of a preferred embodiment and the accompanying drawings in which:

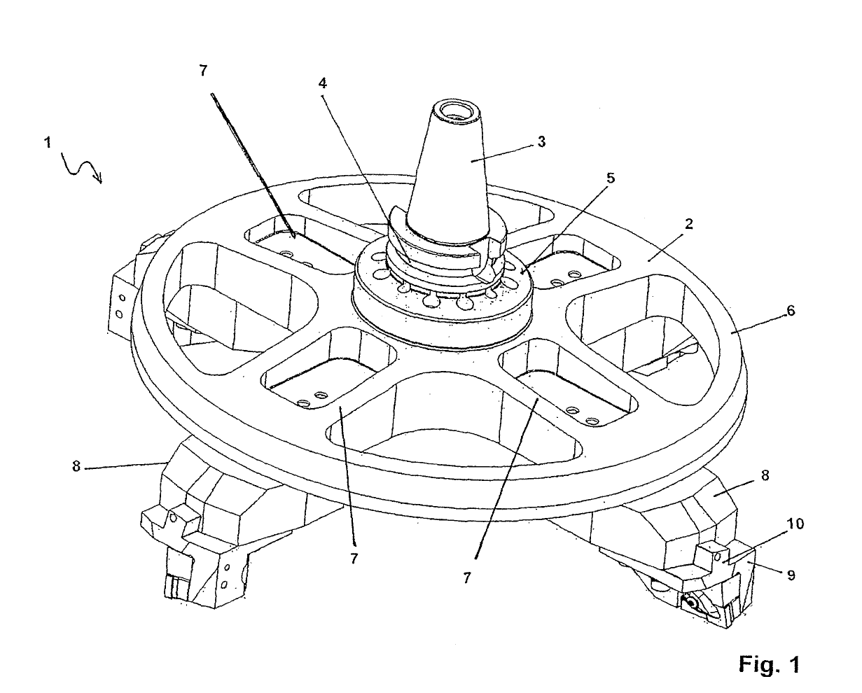

FIG. 1 shows a perspective view of an embodiment of the invention,

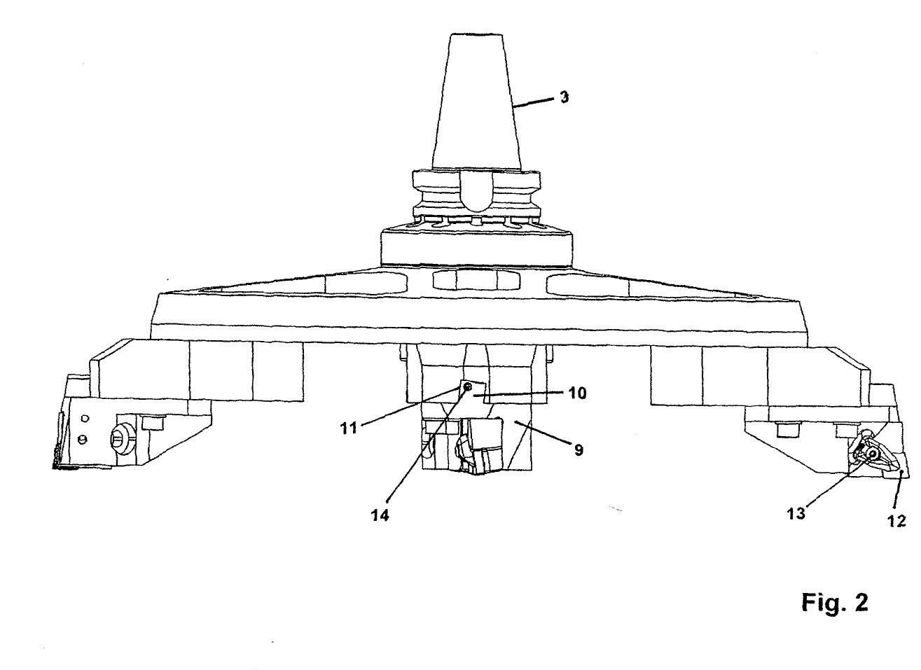

FIG. 2 shows a side view of the FIG. 1 embodiment,

FIG. 3 shows a further perspective view of the FIG. 1 embodiment,

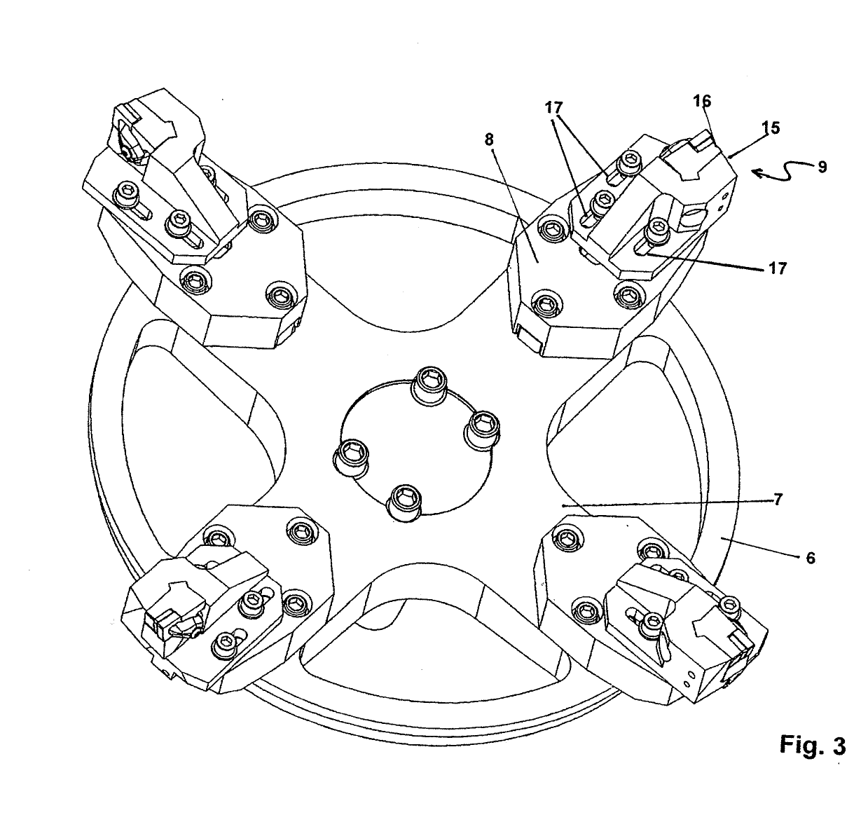

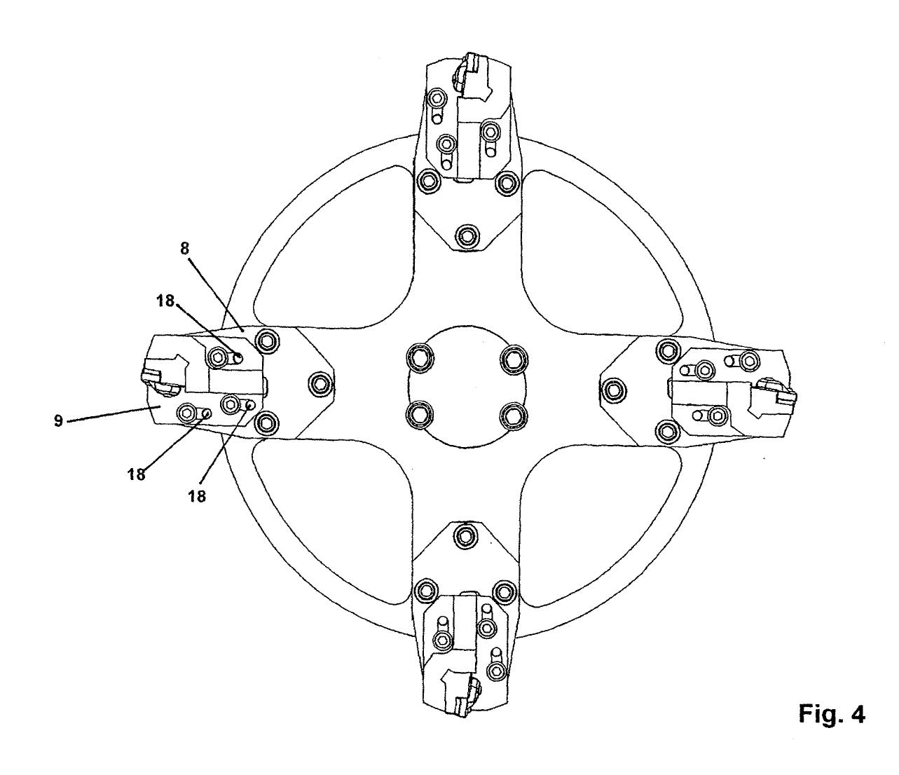

FIG. 4 shows a view from below of the FIG. 1 embodiment,

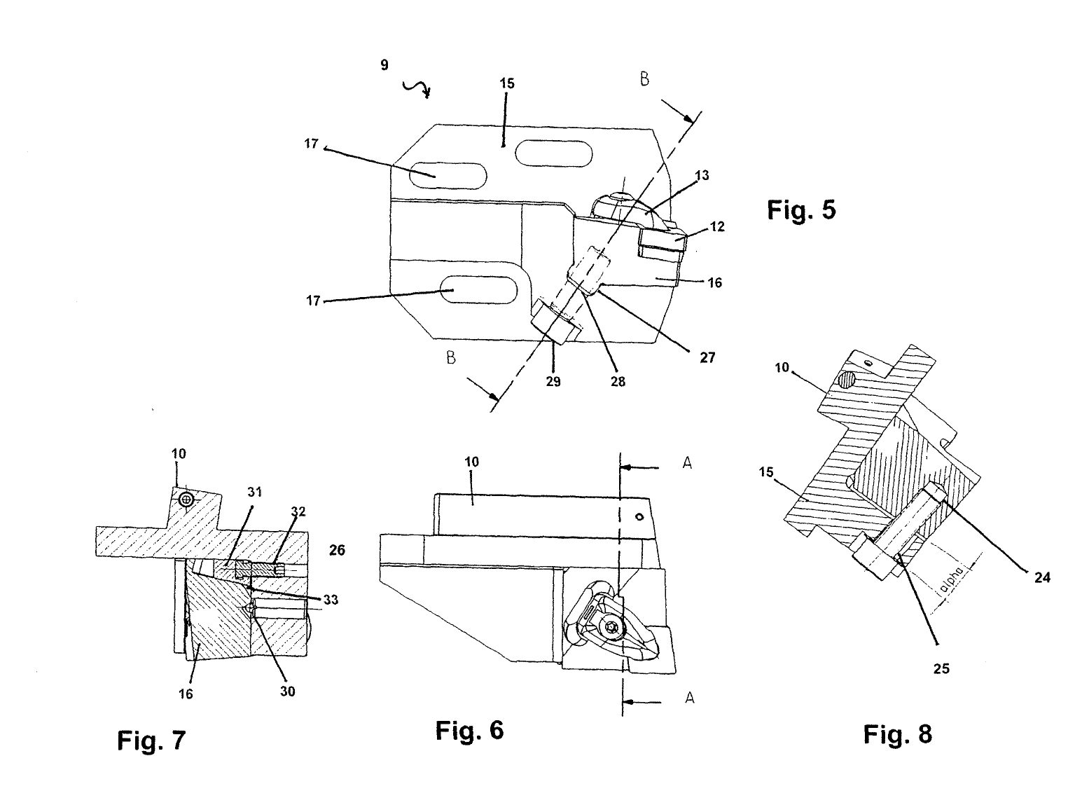

FIG. 5 shows a plan view of a slider body,

FIG. 6 shows a side view of the slider body of FIG. 5,

FIG. 7 shows a sectional view along line A-A in FIG. 6, and

FIG. 8 shows a sectional view along line B-B in FIG. 5.

FIG. 1 shows a perspective view of an embodiment of the invention. A boring-out tool 1 has a main tool body 2 which has an interface 3 with a corresponding drive. Here the interface 3 comprises a steeply tapering shaft 3, at whose end that is towards the main tool body are provided a gripping groove 4 and a flange 5 for axial support. The interface can also be in the form of a separate component which can be connected to the main tool body 2. In that case the interface desirably has a centering pin (not shown) which projects axially beyond the flange 5 and which can engage into a corresponding central bore (not shown) in the main tool body 2.

The main tool body here has a wheel-shaped portion 6 connected to an inwardly disposed hub portion by way of corresponding spoke portions 7. Extension arms 8 are mounted to the main tool body 2 or the spoke portions 7 thereof. The illustrated embodiment has four spoke portions 7, to each of which is mounted a respective extension arm 8. Carried on the extension arm 8 is a cutting insert holder 9 having a leg-like projection 10 which is disposed in a groove 11 in the extension arm 8.

FIG. 2 shows a side view of the FIG. 1 embodiment. It will be seen here that the cutting insert holder 9 has a seat for a cutting insert 12 which is held on the cutting insert holder by means of a clamp 13. It can best be seen in respect of the extension arm 8 shown in the center in FIG. 2 that the leg-like projection 10 is slightly inclined, which in operation leads to a better axial contact pressure. The screw 14 arranged within the leg-like projection 10 serves for radial displacement of the cutting insert holder 9 within the slot 11 in the extension arm 8.

FIG. 3 shows a perspective view from below and FIG. 4 shows a view from below onto the embodiment of FIGS. 1 and 2. It can be clearly seen here that the main tool body 2 comprises an inner hub portion, a wheel-shaped portion 6 and four spoke portions 7. The extension arms 8 are screwed to the spoke portions 7. The cutting insert holder 9 which in turn comprises a slider body 15 and a holding element 16 which is accommodated therein and which includes the cutting insert seat has at least one slot, in the illustrated embodiment three slots 17 can be seen. The extension arm 8 has a corresponding number of threaded bores 18 so that the cutting insert holder 9 can be radially adjusted by means of the slots 17. As already mentioned that is effected by means of the adjusting screw 14 (see FIG. 2).

It can be clearly seen from the view in FIG. 4 that the extension arm 8 has a second set of threaded bores 18. The cutting insert holder 9 can therefore be completely released from the extension arm 8 and fastened again by means of the additional threaded bores at a position radially spaced therefrom. In the new position also the slots 17 allow a certain radial displacement of the cutting insert holder relative to the extension arms 8.

To enlarge the range of boring diameters however not only can the cutting insert holder be displaced relative to the extension arm, but it is also possible to use an extension arm 8 of another configuration or a main tool body 2 of another configuration. It is also possible to use main tool bodies with a different number of spoke portions. In addition it is not absolutely necessary that the individual spoke portions are arranged equidistantly in the peripheral direction. On the contrary, with a so-called differential pitch division, it has been found that vibrations which can occur in operation can be minimized.

FIG. 5 shows a plan view of a slider body 15. The slider body 15 forms together with the holding element 16 the cutting insert holder 9. At its underside the slider body 15 has a leg-like projection 10 which can be inserted into a groove 11 in the extension arm 8. Three screws serve for fastening the slider body 15 to the extension arm 8, the screws engaging into corresponding threaded bores in the extension arm. In the fastening procedure they engage through corresponding slots 17 in the slider body 15 so that when the screws are released the slider body 15 can be reciprocated radially between two positions. As soon as the slider body 15 is in the desired position it can be fastened to the extension arm 8 by means of the screws.

The holding element 16 has a clamp 13 with which the cutting insert 12 can be held in the holding element 16. The slider body 15 has a groove 28 in which a corresponding leg 27 of the holding element 16 engages. A fastening screw 29 is used for fastening the holding element 16 in the groove 28.

As can be seen in particular in FIG. 8 showing a sectional view along line B-B the fastening screw 29 has some play in the slider body 15. The angle a shown in FIG. 8 between the bottom of the groove 28 and the contact surface for the head of fastening screw 29 is preferably >0° and is best in the range of between 0° and 10°.

FIG. 7 shows a sectional view along line A-A in FIG. 6. It will be seen that at its underside the holding element 16 has a bevel 33 and a V-shaped opening. The slider body 15 has a spring element 30 in the form of a resilient pressure portion which projects under a spring effect into the opening provided for the holding element 16. In addition a contact portion in the form of a wedge 31 is fastened to the slider body 15 by means of an adjusting screw 32. When the holding element 16 is fitted into the groove 28 in the slider body 15 the holding element 16 is inserted from below upwardly into the slider body 15 in FIG. 7. In that case firstly the resilient pressure portion 30 will come into contact with the bevel 33. The bevel 33 causes the resilient pressure portion 30 to be pushed into the slider body 15 (towards the left in FIG. 7) until the V-shaped opening comes to lie opposite the pressure portion 30. That situation is shown in FIG. 7. In that situation the holding element 16 butts against the wedge 31. The wedge 31 can be moved by means of the adjusting screw 32, thereby providing for axial displacement of the holding element 16. Finer adjustment is possible by the wedge 31.

The spring element 30 is there essentially to press the holding element 16 along the groove 28 in the direction of the wedge 31 when the wedge 31 is moved back. As soon as the axial position of the holding element is reached the holding element 16 can be fixed to the slider body 15 by means of the fastening screw 29.

It will be appreciated that all features as can be seen by a man skilled in the art from the present description, the drawings and the claims, even if they are described in specific terms only in connection with certain other features, can be combined both individually and also in any combinations with others of the features or groups of features disclosed here insofar as that has not been expressly excluded or technical aspects make such combinations impossible or meaningless. That also applies to any combinations of features within any one of the appendant claims. A comprehensive explicit representation of all conceivable combinations of features is dispensed with here for the sake of brevity and readability of the description.

### LIST OF REFERENCES

1 boring-out tool
2 main tool body
3 interface/steeply tapered shaft
4 gripping groove
5 flange
6 wheel-shaped portion
7 spoke portions
8 extension arms
9 cutting insert holder
10 projection
11 groove
12 cutting insert
13 clamp
14 adjusting screw
15 slider body
16 holding element
17 slots
18 threaded bores
24 second threaded bore
25 through bore
26 first threaded bore
27 leg
28 groove
29 fastening screw
30 spring element
31 wedge
32 adjusting screw
33 bevel

1. A tool for cutting machining for boring or milling comprising a main tool body rotatable about a tool axis and a holding element which can be fastened to the main tool body and has a cutting insert seat, characterized in that there is provided an adjusting device for axially adjusting the holding element in relation to the main tool body.

2. A tool as set forth in claim 1 wherein there is provided a slider body which can be fastened to the main tool body and which is reciprocatable in the radial direction relative to the main tool body between two positions, wherein the holding element can be fastened to the slider body.

3. A tool as set forth in claim 1 wherein the adjusting device has an adjusting screw which is arranged in a first threaded bore in the main tool body or in the slider body and which possibly bears by way of a contact portion against a contact surface of the holding element so that upon rotation of the adjusting screw in the threaded bore the holding element is displaced axially with respect to the slider body or the main tool body.

4. A tool as set forth in claim 3 wherein the first threaded bore includes with the tool axis an angle of between 15° and 165°, preferably between 45° and 135°, particularly preferably between 60° and 120° and best at about 90°.

5. A tool as set forth in claim 3 wherein the contact surface of the holding element and/or a corresponding abutment surface of the adjusting screw or the contact portion, that comes into engagement with the contact surface of the holding element, includes or include with the first threaded bore an angle of between 0° and 90°, preferably between 0° and 20° and particularly preferably between 10° and 20°.

6. A tool as set forth in claim 3 wherein there is provided a spring element which biases the holding element into a given axial position.

7. A tool as set forth in claim 1 wherein the holding element has a second threaded bore and the slider body or the main tool body has a through bore so that the holding element can be fastened to the slider body or to the main tool body with a fixing screw engaging through the through bore into the second threaded bore.

8. A tool as set forth in claim 7 wherein the through bore is in the form of a slot.

9. A tool as set forth in claim 7 wherein the holding element has a leg-shaped projection and the slider body or the main tool body has a corresponding groove, wherein the second threaded bore is arranged in the leg-shaped projection and the through bore is arranged in the groove.

10. A tool as set forth in claim 9 wherein there is provided an abutment surface for the fixing screw head on the slider body or the main tool body, wherein the abutment surface includes with the bottom of the groove an angle (α)>0°, preferably between 1° and 20° and particularly preferably between 1° and 10°.

11. A tool as set forth in claim 7 wherein the second threaded bore includes with the radial direction an angle of between 15° and 165°, preferably between 25° and 135° and particularly preferably between 40° and 50°.

12. A tool as set forth in claim 1 wherein there is provided an extension arm which on the one hand is fastened to the main tool body and which on the other hand carries the cutting insert holder, wherein the cutting insert holder can be fastened to the extension arm at at least two positions spaced from each other in the radial direction.
